(19) United States
(12) Patent Application Publication
(10) Pub. No.: US 2025/0306232 A1
(43) Pub. Date: Oct. 2, 2025

(54) SYSTEMS AND METHODS FOR GEOLOGICAL CHARACTERISTIC DETERMINATION FROM BOREHOLE IMAGES

(71) Applicant: HALLIBURTON ENERGY SERVICES, INC., Houston, TX (US)

(72) Inventors: Bei Li, Singapore (SG); Ho Yin Ma, The Woodlands, TX (US); Zheguang Zou, Singapore (SG)

(73) Assignee: HALLIBURTON ENERGY SERVICES, INC., Houston, TX (US)

(21) Appl. No.: 18/624,267

(22) Filed: Apr. 2, 2024

(51) Int. Cl. G01V 3/18; G01V 3/38

(52) U.S. Cl. CPC G01V 3/18; G01V 3/38

(57) ABSTRACT

Systems and methods for interpreting one or more borehole features are provided herein. The method can include deploying an azimuthal borehole measurement tool into a borehole, obtaining at least one azimuthal borehole image, generating a synthetic image by sparse convolution of a weight function and a plurality of feature kernels, determining an optimal weight function that minimizes a difference between the synthetic image and the at least one azimuthal borehole image, and determining one or more geological characteristics of the borehole based on the optimal weight function and the feature functional representation.

### TECHNICAL FIELD

The present technology pertains to determination of borehole features.

### BACKGROUND

Modern petroleum drilling and production operations require a large quantity of information relating to the parameters and conditions downhole. This information typically includes the location and orientation of the borehole and drilling assembly, earth formation properties, and drilling environment parameters downhole. The collection of information relating to formation properties and conditions downhole is commonly referred to as “logging” and can be performed during the drilling process itself.

### BRIEF DESCRIPTION OF THE DRAWINGS

In order to describe the manner in which the various advantages and features of the disclosure may be obtained, a more particular description of the principles described herein will be rendered by reference to specific embodiments thereof which are illustrated in the appended drawings. Understanding that these drawings depict only example embodiments of the disclosure and are not to be considered to limit its scope, the principles herein are described and explained with additional specificity and detail through the use of the drawings in which:

FIG. 1 illustrates a well during drilling operations in accordance with some aspects of this disclosure;

FIG. 2 illustrates a measurement assembly in accordance with some aspects of this disclosure;

FIG. 3A illustrates an azimuthal borehole image with formation bedding in accordance with some aspects of this disclosure;

FIG. 3B illustrates the unrolling process for an unrolled azimuthal borehole image in accordance with some aspects of this disclosure;

FIG. 3C illustrates an azimuthal borehole image fully unrolled in accordance with some aspects of this disclosure;

FIG. 4 illustrates a flowchart of a method for determining one or more geological characteristics of a borehole in accordance with some aspects of this disclosure;

FIG. 5 illustrates a detailed flowchart of a method for determining one or more geological characteristics of a borehole in accordance with some aspects of this disclosure;

FIG. 6 illustrates an image of micro-resistivity with dips picked from sinusoidal features in accordance with some aspects of this disclosure; and

FIG. 7 illustrates an example of a system for implementing certain aspects of the present technology in accordance with some aspects of the disclosure.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and descriptions are not intended to be restrictive.

The ensuing description provides example aspects only and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

The term “substantially” is defined to be essentially conforming to the particular dimension, shape or other word that substantially modifies, such that the component or characterization need not be exact.

Provided herein are systems and methods for automatic picking of features of borehole images. In some examples, the features can be dips and/or voids/vugs. Dips are defined by a dip angle which is the angle a plane of a formation bed makes with a horizontal plane. Voids are defined as openings in a formation which can include certain materials of interest (e.g., oil and/or gas). Vugs are defined as reservoirs which store oil and gas in carbonate reservoirs. The systems and methods can use sparse inversion based methods to determine features of a borehole image. For example, the sparse inversion based methods can be used to determine sinusoidal parameters (e.g., amplitude, depth, and phase) in a borehole image, which can be used to determine dip angles and dip orientations between formation beddings.

Generally, formations may be electrically isotropic or electrically anisotropic. If a formation is electrically isotropic, the resistivities measured at the various depths of investigation by such a resistivity logging tool will be the same. However, if the resistivities corresponding to the various depths of investigation are different, such differences indicate that the formation being measured is electrically anisotropic. In electrical anisotropic formations, the anisotropy can be attributable to the interface between geological formation beddings. Geological formation beddings may be described in a formation coordinate system. A formation coordinate system can be oriented such that the x-y plane is parallel to the formation layers and the z axis is perpendicular to the formation layers. Formation bedding can also be described using a dip angle.

A dip angle θ can be the inclination from the x-y plane and the bed boundary between two geological formation beddings at a given depth. Dip picking can incorporate determining one or more dip angles θ at one or more depths. During drilling operations dip picking can be performed by determining multiple dip angles θ from azimuthal borehole images. Azimuthal borehole images can be obtained from measuring formation properties such as resistivity or density in different azimuthal directions during drilling operations. Additionally, dip picking can be utilized to determine the angle of formation beddings. The angle of formation beddings can provide useful information for geosteering. This can allow for the navigation along a pre-designed drilling path and indicate in real time the location of the bottom hole assembly within a formation. The real time location of the bottom hole assembly allows for the bottom hole assembly to follow a pre-designed drilling path.

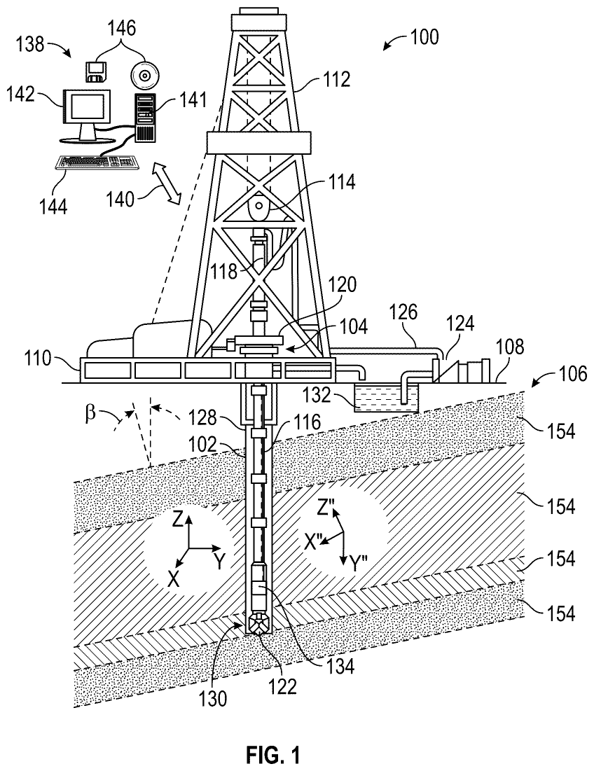

FIG. 1 illustrates a drilling system 100. As illustrated, the borehole 102 may extend from a wellhead 104 into a subterranean formation 106 from a surface 108. Generally, the borehole 102 can include horizontal, vertical, slanted, curved, and other types of borehole geometries and orientations. The borehole 102 can be cased or uncased. In examples, borehole 102 can include a metallic member. By way of example, the metallic member can be a casing, liner, tubing, or other elongated steel tubular disposed in the borehole 102.

As illustrated, the borehole 102 can extend through subterranean formation 106. As illustrated in FIG. 1, the borehole 102 can extend generally vertically into the subterranean formation 106, however the borehole 102 can also extend at an angle through the subterranean formation 106, such as horizontal and slanted boreholes. For example, although FIG. 1 illustrates a vertical or low inclination angle well, high inclination angle or horizontal placement of the well and equipment can be possible. It should further be noted that while FIG. 1 generally depicts land-based operations, those skilled in the art can recognize that the principles described herein are equally applicable to subsea operations that employ floating or sea-based platforms and rigs, without departing from the scope of the disclosure.

As illustrated, a drilling platform 110 can support a derrick 112 having a traveling block 114 for raising and lowering the drill string 116. The drill string 116 can include, but is not limited to, drill pipe and coiled tubing. A kelly 118 can support the drill string 116 as it can be lowered through a rotary table 120. A drill bit 122 can be attached to the distal end of the drill string 116 and can be driven either by a downhole motor and/or via rotation of the drill string 116 from the surface 108. Without limitation, the drill bit 122 can comprise roller cone bits, PDC bits, natural diamond bits, any hole openers, reamers, coring bits, and the like. As the drill bit 122 rotates, it can create and extend the borehole 102 that penetrates various subterranean formations 106. A pump 124 can circulate drilling fluid through a feed pipe 126 through the kelly 118, downhole through interior of the drill string 116, through orifices in the drill bit 122, back to the surface 108 via an annulus 128 surrounding the drill string 116, and into a retention pit 132.

With continued reference to FIG. 1, the drill string 116 can begin at wellhead 104 and may traverse the borehole 102. The drill bit 122 can be attached to a distal end of the drill string 116 and can be driven, for example, either by a downhole motor and/or via rotation of the drill string 116 from the surface 108. The drill bit 122 can be a part of bottom hole assembly (BHA) 130 at distal end of drill string 116. BHA 130 can further include tools for look-ahead resistivity applications. As will be appreciated by those of ordinary skill in the art, BHA 130 can be a measurement-while drilling (MWD) or logging-while-drilling (LWD) system.

BHA 130 can comprise any number of tools, transmitters, and/or receivers to perform downhole measurement operations. For example, as illustrated in FIG. 1, BHA 130 can include a measurement assembly 134. It should be noted that the measurement assembly 134 can make up at least a part of BHA 130. Without limitation, any number of different measurement assemblies, communication assemblies, battery assemblies, and/or the like can form BHA 130 with measurement assembly 134. Additionally, the measurement assembly 134 can form BHA 130 itself. In some examples, the measurement assembly 134 can comprise azimuthal borehole instrumentation for detecting bed boundaries and determining one or more dip angles at one or more depths. In some examples, the measurement assembly 134 can comprise modular resistivity tool with tilted antennas. Additionally, other azimuthal measurement tools can exist such as density imaging tools such as azimuthal litho-density tools. The azimuthal borehole instrumentation may measure the inclination angle, the horizontal angle, and the azimuthal angle (also known as the rotational or “tool face” angle) of the LWD tools. Inclination angle is the deviation from vertically downward, the horizontal angle is the angle in a horizontal plane from true North, and the tool face angle is the orientation (rotational about the tool axis) angle from the high side of the borehole. In some examples, azimuthal borehole instrumentation measurements can comprise three axis accelerometer measurement of the earth's gravitational field vector relative to the tool axis and a point on the circumference of the tool called the “tool face scribe line”. (The tool face scribe line is drawn on the tool surface as a line parallel to the tool axis). From this measurement inclination a tool face angle of the LWD tool can be determined. Additionally, a three-axis magnetometer measures the earth's magnetic field vector in a similar manner. From the combined magnetometer and accelerometer data, the horizontal angle of the LWD tool can be determined. In addition, a gyroscope or other form of inertial sensor can be incorporated to perform position measurements and further refine the orientation measurements.

In some examples, downhole sensors on the measurement assembly 134 can be coupled to a computing system 138. The drill bit 122 can penetrate the formation 106. In some examples, the formation 106 can comprise a series of formation beds 154 dipping at an angle. A first (x, y, z) coordinate system associated with the sensors of the measurement assembly 134 is shown, and a second coordinate system (x, y, z″) associated with the formation beds 154 is be shown. The bed coordinate system has the z″ axis perpendicular to the bedding plane, has the y″ axis in a horizontal plane, and has the x″ axis pointing “downhill”. The angle between the z-axes of the two coordinate systems is referred to as the “dip” and is shown in FIG. 1 as the angle β (e.g., dip angle θ).

Without limitation, BHA 130 and all parts within BHA 130 (for example, measurement assembly 134) can be connected to and/or controlled by the computing system 138, which can be disposed on surface 108. Without limitation, the computing system 138 can be disposed downhole in BHA 130. Processing of information recorded can occur downhole and/or on the surface 108. Processing occurring downhole can be transmitted to the surface 108 to be recorded, observed, and/or further analyzed. Additionally, information recorded on the computing system 138 that is disposed downhole can be stored until BHA 130 is brought to the surface 108. In some examples, the computing system 138 can communicate with BHA 130 through a communication line (not illustrated) disposed in (or on) the drill string 116. In some examples, wireless communication can be used to transmit information back and forth between the computing system 138 and BHA 130. The computing system 138 can transmit information to BHA 130 and can receive as well as process information recorded by BHA 130. In some examples, a downhole computing system (not illustrated) can include, without limitation, a microprocessor or other suitable circuitry, for estimating, receiving and processing signals from BHA 130. Downhole computing system (not illustrated) can further include additional components, such as memory, input/output devices, interfaces, and the like. In examples, while not illustrated, BHA 130 can include one or more additional components, such as analog-to-digital converter, filter and amplifier, among others, which can be used to process the measurements of BHA 130 before they are transmitted to the surface 108. Alternatively, raw measurements from BHA 130 can be transmitted to the surface 108.

Any suitable technique can be used for transmitting signals from BHA 130 to the surface 108, including, but not limited to, wired pipe telemetry, mud-pulse telemetry, acoustic telemetry, and electromagnetic telemetry. While not illustrated, BHA 130 can include a telemetry subassembly that can transmit telemetry data to the surface 108. At the surface 108, pressure transducers (not shown) can convert the pressure signal into electrical signals for a digitizer (not illustrated). The digitizer can supply a digital form of the telemetry signals to the computing system 138 via a communication link 140, which can be a wired or wireless link. The telemetry data can be analyzed and processed by computing system 138.

As illustrated, communication link 140 (which may be wired or wireless, for example) can be provided that can transmit data from BHA 130 to the computing system 138 at the surface 108. The computing system 138 can include a personal computer 141, a video display 142, a keyboard 144 (e.g., other input devices), and/or non-transitory computer-readable media 146 (e.g., optical disks, magnetic disks) that can store code representative of the methods described herein. In addition to, or in place of processing at the surface 108, processing can occur downhole.

Methods and systems can be utilized by the computing system 138 to determine properties of the subterranean formation 106. Information can be utilized to produce an image, which can be generated into a two or three-dimensional model of the subterranean formation 106. These models can be used for well planning, (e.g., to design a desired path of the borehole 102). Additionally, the models can be used for planning the placement of drilling systems within a prescribed area. This can allow for the most efficient drilling operations to reach a subsurface structure. During drilling operations, measurements taken within the borehole 102 can be used to adjust the geometry of the borehole 102 in real time to reach a geological target. Measurements collected from BHA 130 of the formation properties can be used to steer drilling system 100 toward a subterranean formation 106. Additionally, information from the measurement assembly 134 can be gathered and/or processed by the computing system 138. For example, signals recorded by receiver, discussed below, can be stored on memory and then processed by the computing system 138.

The processing can be performed real-time during data acquisition or after recovery of BHA 130. For this disclosure, real-time is a duration of time ranging from about a second to about ten minutes. Processing can alternatively occur downhole or can occur both downhole and at surface. The computing system 138 can process the signals, and the information contained therein can be displayed for an operator to observe and store for future processing and reference. The computing system 138 can also contain an apparatus for supplying control signals and power to BHA 130.

Systems and methods of the present disclosure can be implemented, at least in part, with the computing system 138. While shown at the surface 108, the computing system 138 can also be located at another location, such as remote from borehole 102. Computing system 138 can include any instrumentality or aggregate of instrumentalities operable to compute, estimate, classify, process, transmit, receive, retrieve, originate, switch, store, display, manifest, detect, record, reproduce, handle, or utilize any form of information, intelligence, or data for business, scientific, control, or other purposes. For example, the computing system 138 can be a personal computer 141, a network storage device, or any other suitable device and can vary in size, shape, performance, functionality, and price. The computing system 138 can include random access memory (RAM), one or more processing resources such as a central processing unit (CPU) or hardware or software control logic, ROM, and/or other types of nonvolatile memory. Additional components of the computing system 138 can include one or more disk drives, one or more network ports for communication with external devices as well as various input and output (I/O) devices, such as a keyboard 144, a mouse, and a video display 142. The computing system 138 can also include one or more buses operable to transmit communications between the various hardware components. Furthermore, a video display 142 can provide an image to a user based on activities performed by the personal computer 141. For example, producing images of geological structures created from recorded signals. By way of example, video display unit can produce a plot of depth versus the two cross-axial components of the gravitational field and versus the axial component in borehole coordinates. The same plot can be produced in coordinates fixed to the Earth, such as coordinates directed to the North, East and directly downhole (Vertical) from the point of entry to the borehole. A plot of overall (average) density versus depth in borehole or vertical coordinates can also be provided. A plot of density versus distance and direction from the borehole versus vertical depth can be provided. It should be understood that many other types of plots are possible when the actual position of the measurement point in North, East and Vertical coordinates is taken into account. Additionally, hard copies of the plots can be produced in paper logs for further use.

Alternatively, systems and methods of the present disclosure can be implemented, at least in part, with non-transitory computer-readable media 146. Non-transitory computer-readable media 146 can include any instrumentality or aggregation of instrumentalities that can retain data and/or instructions for a period of time. Non-transitory computer-readable media 146 can include, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing.

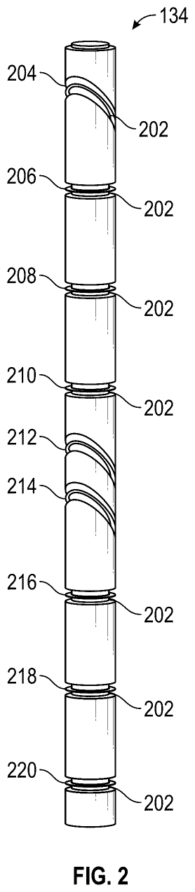

FIG. 2 illustrates a measurement assembly 134. The measurement assembly 134 can include one or more reduced regions 202 of reduced diameter (e.g., indented diameter, grooves, etc.) for supporting transmitters and receivers. In some examples, transmitters and receivers can be formed from coiled wire. Coiled wire can be placed in a reduced region 202 and spaced away from the tool surface by a constant distance. To mechanically support and protect the coiled wire, a non-conductive filler material, such as epoxy, rubber fiberglass, and/or ceramics, can be used to fill in the reduced diameter regions.

The measurement assembly 134 can include one or more transmitters. In some examples, the transmitters can be coaxial. As illustrated, the measurement assembly 134 can have six transmitters, (e.g., first transmitter 206, second transmitter 208, third transmitter 210, fourth transmitter 216, fifth transmitter 218, and sixth transmitter 220). The axes of the first transmitter 206, second transmitter 208, third transmitter 210, fourth transmitter 216, fifth transmitter 218, and sixth transmitter 220 can coincide with the longitudinal axis of the measurement assembly 134. The measurement assembly 134 can include one or more receivers. In some examples, the one or more receivers can be tilted receiver antennas. For example, the one or more receivers can be defined by a plane that is not perpendicular to the longitudinal axis of the measurement assembly 134. As illustrated, the measurement assembly 134 can have three receivers (e.g., first receiver 204, second receiver 212, and third receiver 214). As illustrated, the first receiver 204, second receiver 212, and third receiver 214 can be titled receivers (e.g., are defined by an axis that is not perpendicular to the longitudinal axis of the measurement assembly 134).

In some examples, the first transmitter 206, second transmitter 208, third transmitter 210, fourth transmitter 216, fifth transmitter 218, and sixth transmitter 220 can be tilted and the first receiver 204, second receiver 212, and third receiver 214 can be coaxial. In further examples, the transmitters 206, 208, 210, 216, 218, 220 and the receivers 204, 212, 214 can both be coaxial or can both be tilted. In some examples, the roles of the transmitters 206, 208, 210, 216, 218, 220 and receivers 204, 212, 214 can be interchanged while preserving the usefulness of the measurements made by the measurement assembly 134. Each of the transmitters 206, 208, 210, 216, 218, 220 can be energized sequentially, and the phase and amplitude of the resulting voltage induced in each of the receivers 204, 212, 214 can be measured. From these measurements, or combination of these measurements, azimuthal borehole images can be formed. Azimuthal borehole images can include azimuthal borehole measurements of formation 106.

It will be appreciated that other types of measurement assemblies can be used as alternatives to, or in conjunction, with the measurement assembly 134. For example, measurement assemblies having different numbers of transmitters and receivers can be used, so long as the measurement assemblies are operable to produce an azimuthal borehole image. Further, measurement assemblies operable to measure acoustic pressure amplitudes can be used.

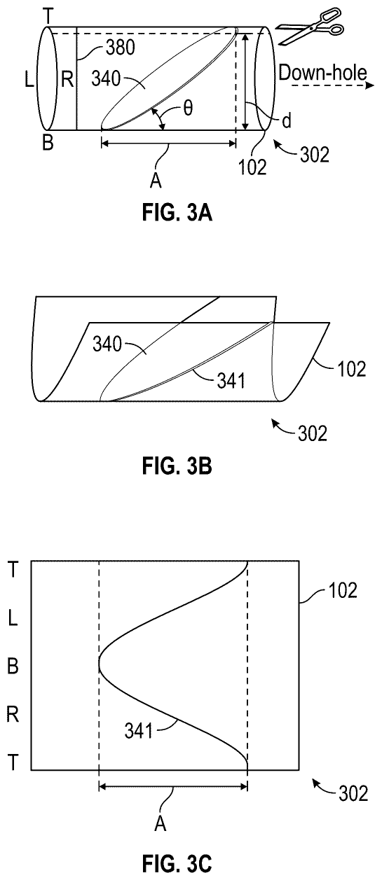

FIGS. 3A-3C illustrate borehole image processing for an azimuthal borehole image. An azimuthal borehole image can be formed using the methods and systems described above. As noted above, a bed boundary 340 can be defined as the interface between two formation beds 154. FIG. 3A illustrates an azimuthal borehole image formed using the methods and systems described above. Within the formed azimuthal borehole image can be measured properties of a bed boundary 340, an intersecting line 341, a borehole diameter d, and a dip spin A. The intersecting line 341 can be an interface of bed boundary 340 and dip spin A can be the amplitude of the sinusoid selected to represent intersecting line 341. The azimuthal direction of borehole 102 can be marked T for top of the borehole 102, B for bottom of the borehole 102, L for left of the borehole of 102, R for right of the borehole 102, and bed boundary 340 intercepting at an angle θ with a dip spin A. The azimuthal borehole image can be sliced along a vertical axis 380 to yield an unrolled azimuth borehole image 302. FIG. 3B illustrates the unrolling process for unrolled azimuth borehole image 302 across T for the top of borehole 302. FIG. 3C illustrates sliced azimuthal borehole image 302 fully unrolled. Sliced azimuthal borehole image 302 can be mapped with bed boundary 340 to form a sinusoid selected to represent intersecting line 341 in the azimuthal borehole image 302. The sinusoid selected to represent intersecting line 341 can be utilized by the computing system 138 to identify and pick dips within formation beds 154. It will be appreciated that the unrolled azimuthal borehole image 302 can also be used to determine other geological features (e.g., vugs/voids).

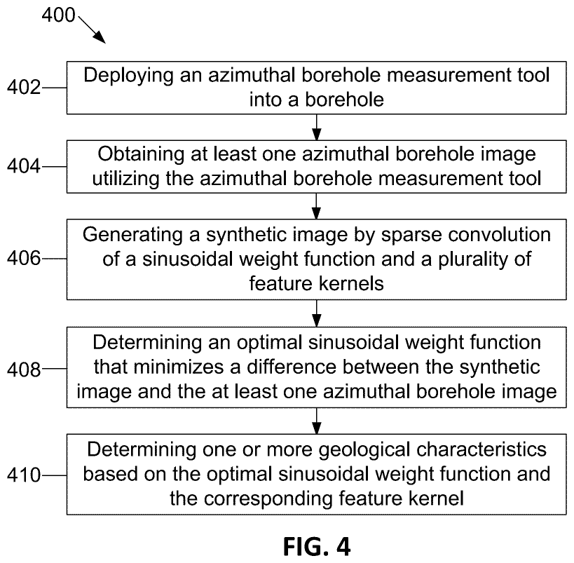

FIG. 4 illustrates a flowchart for a method 400 for interpreting one or more features of an azimuthal borehole image. In some examples, the method 400 can be used for dip picking one or more dips from an azimuthal borehole image. At block 402, the method can include deploying an azimuthal borehole measurement tool (e.g., measurement assembly 134) into a borehole. For example, the azimuthal borehole measurement tool can be lowered downhole into the borehole. In some examples, the azimuthal borehole measurement tool can be operable to measure characteristics of the borehole in an open hole, a cased hole, or through-tubing. In some examples, the azimuthal borehole measurement tool can perform acoustic, electromagnetic, micro-resistivity, nuclear, and optical imaging.

At block 404, the method 400 can include obtaining at least one azimuthal borehole image utilizing the azimuthal borehole measurement tool. For example, the azimuthal borehole measurement tool can obtain logging data such as acoustic, electromagnetic, micro-resistivity, nuclear, and optical data that can be transformed into an azimuthal borehole image. In some examples, the at least one azimuthal borehole image can be preprocessed using image processing algorithms such as automated gain control, wavenumber filtering, or other image processing techniques.

The method 400 can include performing a sparse inversion based action. The sparse inversion based action utilizes a convolutional model having a weight function and a seed function (e.g., feature functional representation and/or feature kernel) to generate a synthetic image (e.g., the synthetic image is a mathematical convolutional equation). The synthetic image for each weight function is compared to the azimuthal borehole image in a cost function. The weight function parameters of the synthetic equation are changed until the cost function is minimized. The synthetic image that minimizes the cost function is the synthetic image that most closely matches (e.g., resembles the characteristics of) the azimuthal borehole image. Minimized can be defined as a difference of about 1% to about 10% between the synthetic image and the azimuthal borehole image. In some examples, minimized can mean a change of 10% or less, or 5% or less, or 1% or less, between a previous inversion result (e.g., the comparison of the synthetic image to the azimuthal borehole image) and a subsequent inversion result (e.g., the comparison of the synthetic image with updated parameters to the azimuthal borehole image). Previous inversion results means a previous iteration and subsequent inversion result means a subsequent iteration. For example, the when the cost function indicates a less than 10% to about less than 1% difference between iterations, the cost function can be minimized. In some examples, minimizing the cost function can be completed when changing the parameters of the synthetic image cannot reduce a gradient (e.g., difference) between the synthetic image and the azimuthal borehole image. For example, minimized can be defined as the local minima, where the synthetic image most closely resembles the azimuthal borehole image. The parameters of the synthetic image for the minimized cost function are therefore the equation (for example, weight function and feature functional representation, also referred to as feature kernel scaled by a corresponding weight function) for the extracted feature. The parameters of the synthetic image can then be used to determine geological properties of the borehole. For example, one or more borehole features can be extracted and/or determined from the azimuthal borehole image utilizing the sparse based inversion action. The one or more borehole features can include sinusoidal waves which can be indicative of dips in the formation bedding and/or vugs and/or voids which are openings indicative of carbonate reservoirs. In some examples, the sparse inversion based action can be operable to determine a phase, depth, and amplitude of a sinusoid in the azimuthal borehole image.

At block 406, the method 400 can include generating a synthetic image by sparse convolution of a sinusoidal weight function and a plurality of sinusoidal feature kernels (e.g., plurality of feature functional representations) with different amplitudes. In some examples, the sparse inversion based action can begin by generating a synthetic image Î. In some examples, the synthetic image Î can be generated using forward modeling. The synthetic image Î can be generated using a sparse 2D convolution between sinusoidal weight in an (x, z) plane (for example, phase and depth) and a series of sinusoidal waves with different amplitudes (e.g., plurality of feature kernels). The synthetic image can be described by Eq. 1.

$$\hat{I} ( x , z ) = {\sum }_{i = 1}^{N} f ( x , z ; {A}_{i} ) * g ( x , z ; {A}_{i} ) \qquad ( Eq . 1 )$$

In Eq. 1, Î(x, z) is the preprocessed or synthetic image. ƒ(x, z; A) is the weight for the sinusoidal wave g (x, z; A), where A is in a predetermined range. The predetermined range can be determined based on a geology of the drilling area (e.g., wellbore). For example, the predetermined range can be up to about 50 feet when the wellbore is a horizontal wellbore. In other types of drilling areas, the predetermined range can be selected dependent on the type of wellbore. ƒ can be accounted for with the variation on the measured physical quantity for the image. For example, the measured physical quantity can be electrical resistivity, acoustic pressure amplitude, etc.

At block 408, the method 400 can include determining an optimal weight function (e.g., sinusoidal weight functions) (e.g., ƒ(x, z, A)) that minimizes a difference between the synthetic image and the azimuthal borehole image. Once the synthetic image is generated, an inverse problem can be solved to determine the sinusoidal properties by optimizing the weight ƒ(x, z; A) for the sinusoidal wave. For example, the optimal weight function can be determined by overlaying the synthetic image with the plurality of kernel features scaled by corresponding sinusoidal weight functions on the azimuthal borehole image, where the optimal sinusoidal weight function is the corresponding sinusoidal weight function of the plurality of feature kernels which produces the synthetic image substantially matching the azimuthal borehole image. The inverse problem can be formulated as Eq. 2.

$$J ( f \vert I ) = ‖ I ( x , z ) - \hat{I} ( x , z ) ‖ = ‖ I ( x , z ) - {\sum }_{i = 1}^{N} f ( x , z ; {A}_{i} ) * g ( x , z ; {A}_{i} ) ‖ \qquad ( Eq . 2 )$$

In Eq. 2, J is a cost function, which is defined as the difference between the input image I (e.g., the azimuthal borehole image obtained from the measurements of the azimuthal borehole tool) and the synthetic image Î. The cost function J is minimized to solve the inverse equation, thereby determining the properties of the sinusoidal wave (e.g., the properties of the sinusoidal wave are given by the synthetic image Î(defined by ƒ and g) which minimizes the cost function). ƒ is the sparse solution. In some examples, ƒ can be assumed to have only one non-zero entry in the (x, A) domain given a value for z. The sinusoidal wave function, g (z, x; Aᵢ), is also considered highly sparse in the (x, z) domain such that the dictionary (e.g., number of possible sinusoidal functions with different amplitudes) is targeted for sinusoidal waves. In this example, g (z, x; Aᵢ) is for sinusoidal features, however, g (z, x; Aᵢ) can be indicative of any desired feature functional representation (e.g., feature kernel) (e.g., voids which are circular or elliptical, etc.) Eq. 3 below illustrates the solution to the inverse problem.

$${min}_{f} J ( f \vert I ) \qquad ( Eq . 3 )$$

In some examples, the inverse problem can be solved by various methods. In some examples, the inverse problem can be solved by gradient hard thresholding pursuit. Gradient hard thresholding pursuit can enforce the sparsity of ƒ(x, z; A) by preserving the largest-k elements in each step gradient along x and A, given z. In some examples, the largest-k elements include 1, 2, 3, 4, 5, 6, 7, 8, 9, 10 or more weight functions ƒ. A computing system can compare the synthetic image generated by each weight function ƒ to the azimuthal borehole image to determine spikes (e.g., where the synthetic image overlaps with the azimuthal borehole image). In some examples, the computing system is configured to overlay the synthetic image generated with the plurality of feature kernels (e.g., g with a plurality of amplitudes) scaled by corresponding weight functions ƒ and compare (e.g., determine spikes) between the synthetic image with different weight functions and the azimuthal borehole image to determine which weight functions ƒ to retain for a further iteration. The retained weight functions ƒ can be adjusted or additional weight functions based on the retained weight functions can be used to further optimize the synthetic image. At the end of the inversion, the largest single spike in the ƒ(x, A) plane can be chosen for each of a plurality of depths (z). The solution to the inverse problem is the determined functional feature representation (e.g., sinusoidal wave function g(z, x; A)) with the optimal ƒ providing the closest representation to the azimuthal borehole image (e.g., the parameters of the synthetic image that minimize the cost function).

In comparison to traditional sinusoidal feature extraction methods, the sparse inversion based extraction can provide significantly improved efficiency and require significantly less computational resources. For example, traditional sinusoidal feature extraction methods, such as Radon Transform-based methods (e.g., Hough Transform), generally involve stacking along tentative sine trajectories on the borehole image for each depth, so that a semblance is obtained. In these traditional methods, the amplitude and phase are picked manually or automatically. As there are two controlling parameters (amplitude and phase) for a sine trajectory, the stacking needs to be performed N times at each depth, where N is O(n_{A}×nₓ) and n_{A} and nₓ are sampling numbers along amplitude and phase. These traditional methods are computationally demanding, especially for large-size borehole images.

In contrast, the sparse inversion based action described herein does not require scanned stacking at each depth. Rather, the sparse 2D convolution effectively performs “stacking” at O(k×Nᵢₜₑᵣ) at each depth, where k is the preserved number of spikes in ƒ(x, A) and Nᵢₜₑᵣ is the iteration number of the inversion. Compared to O(n_{A}×nₓ), O(k×Nᵢₜₑᵣ) is much smaller, therefore significantly reducing the computational cost using the sparse inversion based method.

In some examples, the method 400 can be operable to determine other shapes, features, and/or geometries in an azimuthal borehole image. For example, by changing the sinusoidal wave function (e.g., feature kernel) g (z, x, A) to a desired feature functional representation (e.g., feature kernel), such as functional representations for voids, vugs, etc. Voids and vugs indicate openings in carbonate reservoirs.

At block 410, the method 400 can include determining one or more geological characteristics based on the optimal sinusoidal weight function, ƒ, and the sinusoidal wave function, g. For example, the geological characteristics can be dip angle (e.g., the angle of the dip between formation beddings) and dip orientation (e.g., the azimuth of the dip between formation beddings) which can be determined based on the optimal synthetic image (for example., synthetic image with optimized sinusoidal weight function and sinusoidal wave function). In some examples, the geological characteristics can include voids or vugs in the formation.

The method 400 can further include geosteering a downhole drilling tool based on the one or more geological characteristics of the borehole. For example, the downhole drilling tool can be steered in an optimal borehole direction based on the one or more geological characteristics.

Blocks 406, 408 can be repeated multiple times for a single azimuthal borehole image such that multiple functional feature representations (e.g., feature kernels) (e.g., sinusoidal wave g (z, x; Aᵢ)) with optimized parameters (e.g., ƒ(z, x; A)) are generated. For example, there can be multiple dips in a single azimuthal borehole image and functional feature representations (e.g., sinusoidal wave g (z, x; Aᵢ)) with optimized parameters (e.g., ƒ(z, x; A)) for all the dips can be generated. Similarly, a single azimuthal borehole image can include multiple voids and a functional feature representation with optimized parameters for all of the voids can be generated.

In some examples, method 400 can be repeated at various stages of the drilling process. For example, the method 400 can be repeated to ensure that the drilling process is following the correct path.

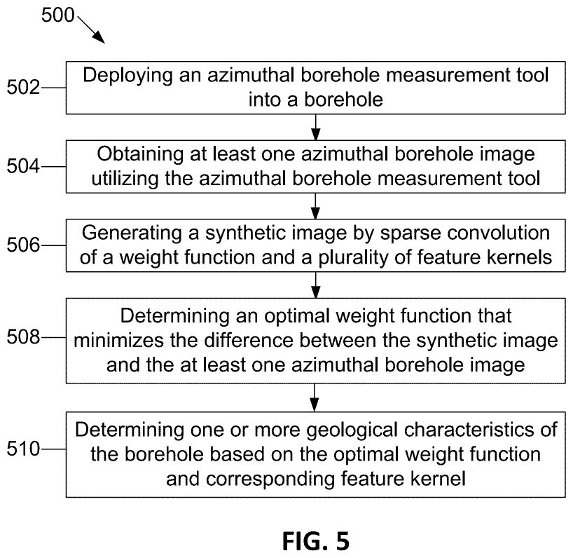

FIG. 5 illustrates a method 500 for interpreting one or more features of a borehole. The one or more features of the borehole can be any features that can be functionally represented (e.g., sinusoidal waves, circular or elliptical shapes, etc.) For example, dips in formation beddings (e.g., the change between a first type of formation material to a second type of formation material) can be functionally represented as sinusoidal waves. Voids in a borehole can be functionally represented as circular or elliptical shapes. In some examples, vugs can be functionally represented as circular shapes.

At block 502, the method 500 can begin by deploying an azimuthal measurement tool into a borehole, as described herein. At block 504, the method 500 can include obtaining an azimuthal borehole image from the azimuthal borehole tool, as described herein. In some examples, the azimuthal borehole image can be preprocessed using image processing algorithms such as automated gain control, wavenumber filtering, or other image processing techniques. For example, the azimuthal borehole image can be preprocessed to remove low wavenumber or other noises that cannot be synthesized by the sparse inversion based convolution method.

At block 506, the method can include generating a synthetic image by sparse convolution of a weight function, ƒ, and a plurality of feature kernels (e.g., feature functional representations), g. In some examples, the synthetic image can be normalized before performing the inversion. The feature functional representation (e.g., feature kernel), g, can be a function describing a specific feature, for example sinusoidal waves for dips, circular or elliptical functions for voids and/or vugs, and other functions describing features in a borehole. The synthetic image Î can be generated using a sparse 2D convolution between a weight function in an (x, z) plane (for example, phase and depth) and a series of weight kernels with different parameters (e.g., amplitudes). In some examples, the synthetic image Î can be described by Eq. 4.

$$\hat{I} ( x , z ) = {\sum }_{i = 1}^{N} f ( x , z ; {C}_{i} ) * g ( x , z ; {C}_{i} ) \qquad ( Eq . 4 )$$

In Eq. 4, Î(x, z) is the preprocessed or synthetic image. ƒ(x, z; C) is the weight function for the feature functional representation (e.g., feature kernel) g (x, z; C), where C is a parameter characteristic of the feature functional representation (e.g., feature kernel). For example, if the feature functional representation (e.g., feature kernel) is for sinusoidal waves, Cis amplitude. In other examples, C can be one or more parameters. For example, some feature functional representations (e.g., feature kernels) can require more than a single parameter, in this example, C can represent one or more parameters. ƒ can be accounted for with the variation on the measured or calculated physical quantity for the image. For example, the measured or calculated physical quantity can be electrical resistivity, acoustic pressure amplitude, and/or other measured and/or calculated physical quantities. Once the synthetic image is generated, an inverse problem can be solved to optimize the weight function, ƒ.

At block 508, the method 500 can include determining an optimal weight function ƒ that minimizes the difference between the synthetic image and the azimuthal borehole image. The optimal weight function ƒ can be determined by overlaying the synthetic image with the plurality of feature kernels scaled by corresponding weight functions on the at least one azimuthal borehole image, where the optimal weight function is the corresponding weight function of the plurality of feature kernels which produces the synthetic image substantially matching the azimuthal borehole image. The inverse problem can be described by Eq. 5.

$$J ( f \vert I ) = ‖ I ( x , z ) - \hat{I} ( x , z ) ‖ = ‖ I ( x , z ) - {\sum }_{i = 1}^{N} f ( x , z ; {C}_{i} ) * g ( x , z ; {C}_{i} ) ‖ \qquad ( Eq . 5 )$$

In Eq. 5, J is a cost function, which is defined as the difference between the input image/(e.g., the azimuthal borehole image obtained from the measurements of the azimuthal borehole tool) and the synthetic image, Î. The cost function J is minimized to solve the inverse equation, thereby determining the parameters (e.g., weight) (ƒ (x, z; C)) of the feature functional representation (e.g., feature kernel) (g (x, z; C)). ƒ is the sparse solution. In some examples, ƒ can be assumed to have only one non-zero entry in the (x, C) domain given a value for z. In other examples, ƒ can be assumed to have one or more non-zero entries in the (x, C) domain for a given value of z depending on the properties of the feature functional representation (e.g., feature kernel). The feature functional representation (e.g., feature kernel), g (z, x; Aᵢ), is also considered highly sparse in the (x, z) domain such that the dictionary (for example, number of possible feature functional representations (e.g., feature kernels)) is targeted for the feature to be represented. Eq. 6 illustrates the solution to the inverse problem.

$${min}_{f} J ( f \vert I ) \qquad ( Eq . 6 )$$

The inverse problem can be solved by various methods. In some examples, the inverse problem can be solved by gradient hard thresholding pursuit. Gradient hard thresholding pursuit can enforce the sparsity of ƒ(x, z; C) by preserving the largest-k elements in each step gradient along x and C, given z. In some examples, the largest-k elements include 1, 2, 3, 4, 5, 6, 7, 8, 9, 10 or more weight functions ƒ. A computing system can compare the synthetic image generated by each feature kernel scaled by the corresponding weight function ƒ to the azimuthal borehole image to determine spikes (e.g., where the synthetic image overlaps with the azimuthal borehole image). In some examples, the computing system is configured to overlay the synthetic image with a plurality of feature kernels scaled by corresponding weight functions and compare (e.g., determine spikes) between the synthetic image with the plurality of feature kernels scaled by corresponding weight functions and the azimuthal borehole image to determine which weight functions ƒ to retain for a further iteration. The retained weight functions ƒ can be adjusted or additional weight functions based on the retained weight functions can be used to further optimize the synthetic image. The computing system is operable to evaluate the overlaid synthetic image for each weight function ƒ and determine the optimal weight function ƒ that most closely matches the azimuthal borehole image. At the end of the inversion, the largest single spike in the ƒ(x, C) plane can be chosen for each of a plurality of depths (z). The solution to the inverse problem is the determined feature functional representation (e.g., feature kernel), g, with the optimal weight function, ƒ, that gives the closest representation to the azimuthal borehole image (e.g., the parameters of the synthetic image that minimize the cost function).

At block 510, the method 500 can include determining one or more geological characteristics of the borehole based on the optimal weight function ƒ and feature functional representation (e.g., feature kernel) g. The optimal ƒ includes the inverted parameters for the feature functional representation (e.g., feature kernel) g, thereby providing a mathematical model of the one or more borehole features. The mathematical model of the one or more borehole features can be used to determine one or more geological characteristics of the borehole. For example, the feature functional representation (e.g., feature kernel) can be a sinusoidal function with the optimal parameters (e.g., optimal weight function). The sinusoidal function can represent a dip between formation beddings. The sinusoidal function can be used to determine a dip angle and orientation (azimuth) that can be used to guide geosteering while drilling the borehole. In another example, the feature functional representation (e.g., feature kernel) can represent vug/void features in carbonate rocks.

Blocks 506, 508, 510 can be repeated multiple times for a single azimuthal borehole image such that multiple functional feature representations with optimized parameters are generated. For example, there can be multiple dips in a single azimuthal borehole image and functional feature representations with optimized parameters for all the dips can be generated. Similarly, a single azimuthal borehole image can include multiple voids and a functional feature representation with optimized parameters for all of the voids can be generated.

In some examples, method 500 can be repeated at various stages of the drilling process. For example, the method 500 can be repeated to ensure that the drilling process is following the correct path.

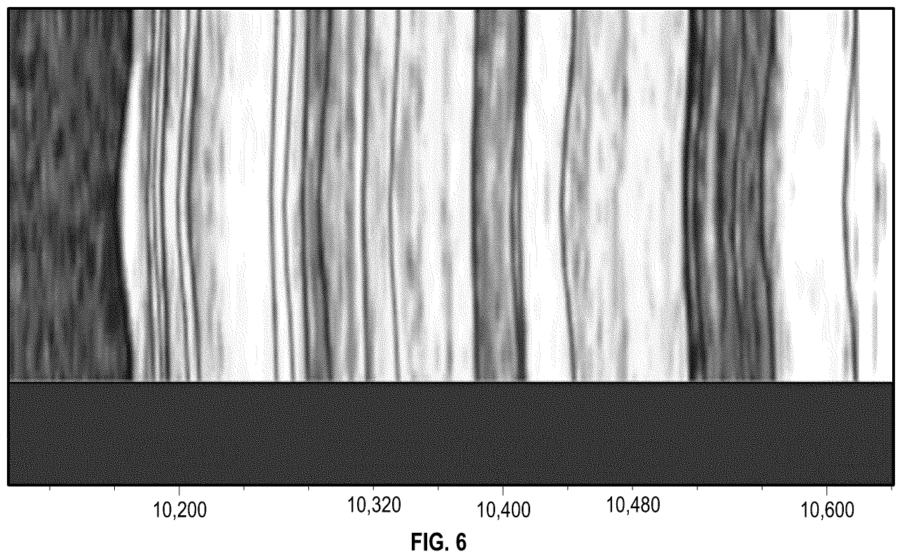

FIG. 6 illustrates an image of micro-resistivity with dips picked from sinusoidal features according to methods 400, 500. As illustrated, sinusoidal waves have been determined and overlayed on the micro-resistivity azimuthal borehole image at a plurality of depths. The methods 400, 500 can accurately and effectively pick dips in the azimuthal borehole image.

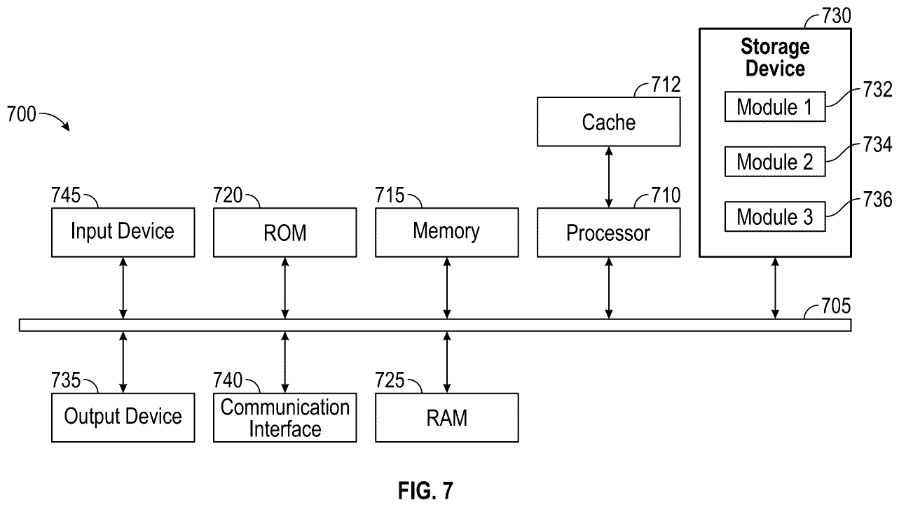

FIG. 7 is a diagram illustrating an example of a system for implementing certain aspects of the present technology in accordance with some aspects of the disclosure. In particular, FIG. 7 illustrates an example of computing system 700, which can be for example any computing device making up an internal computing system, a remote computing system, a sensor, or any component thereof in which the components of the system are in communication with each other using connection 705. Connection 705 can be a physical connection using a bus, or a direct connection into processor 710, such as in a chipset architecture. Connection 705 can also be a virtual connection, networked connection, or logical connection. The example computing system 700 can be utilized to perform methods 400, 500.

In some aspects, computing system 700 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 700 includes at least one processing unit (CPU or processor) 710 and connection 705 that couples various system components including system memory 715, such as ROM 720 and RAM 725 to processor 710. Computing system 700 can include a cache 712 of high-speed memory connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 can essentially be a completely self-contained computing system, containing multiple cores or processors, a bus, memory controller, cache, etc. A multi-core processor can be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms. In some instances, multimodal systems can enable a user to provide multiple types of input/output to communicate with computing system 700. Computing system 700 can include communications interface 740, which can generally govern and manage the user input and system output. The communication interface can perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, lamb wave signal transfer, microwave signal transfer, infrared signal transfer, visible light signal transfer, ultraviolet light signal transfer, wireless signal transfer along the electromagnetic spectrum, or some combination thereof. The communications interface 740 can also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 730 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 730 can include software services, servers, services, etc., that when the code that defines such software is executed by the processor 710, it causes the system to perform a function. In some aspects, a hardware service that performs a particular function can include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as CD or DVD, flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, or the like.

In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, one or more network interfaces configured to communicate and/or receive the data, any combination thereof, and/or other component(s). The one or more network interfaces can be configured to communicate and/or receive wired and/or wireless data, including data according to the 3G, 4G, 5G, and/or other cellular standard, data according to the Wi-Fi (802.11x) standards, data according to the Bluetooth™ standard, data according to the IP standard, and/or other types of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations can be re-arranged. A process is terminated when its operations are completed but can have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices, or other small form factor personal computers, personal digital assistants, rackmount devices, standalone devices, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as RAM such as synchronous dynamic random access memory (SDRAM), ROM, non-volatile random access memory (NVRAM), EEPROM, flash memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more DSPs, general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Numerous examples are provided herein to enhance understanding of the present disclosure. A specific set of statements are provided as follows.

Statement 1: A method for determining one or more geological characteristics of a borehole, the method comprising: deploying an azimuthal borehole measurement tool into a borehole; obtaining at least one azimuthal borehole image utilizing the azimuthal borehole measurement tool; generating a synthetic image by sparse convolution of a weight function and a plurality of feature kernels; determining an optimal weight function that minimizes a difference between the synthetic image and the at least one azimuthal borehole image by overlaying the synthetic image with the plurality of feature kernels scaled by corresponding weight functions on the at least one azimuthal borehole image, wherein the optimal weight function is the corresponding weight function of the plurality of feature kernels which produces the synthetic image substantially matching the at least one azimuthal borehole image; and determining the one or more geological characteristics of the borehole based on the optimal weight function and corresponding feature kernel. Statement 2: The method according to Statement 1, wherein the one or more geological characteristics include one or more dips between formation beds and/or one or more voids, wherein the one or more dips between formation beds include a dip angle and a dip orientation. Statement 3: The method according to Statement 1 or 2, wherein determining the optimal weight function includes overlaying the synthetic image with the plurality of feature kernels scaled by corresponding weight functions for a plurality of iterations, wherein each iteration retains one or more of the plurality of feature kernels scaled by the corresponding weight functions most closely matching the at least one azimuthal borehole image. Statement 4: The method according to any one of preceding Statements 1-3, the method further comprising steering a downhole drilling tool based on the one or more geological characteristics. Statement 5: The method according to any one of preceding Statement 1-4, wherein determining the optimal weight function that minimizes the difference between the synthetic image and the at least one azimuthal borehole image comprises solving an inversion equation using gradient hard thresholding pursuit. Statement 6: The method according to any one or preceding Statements 1-5, wherein the at least one azimuthal borehole image is preprocessed prior to determining the optimal weight function, wherein the at least one azimuthal borehole image is preprocessed using automated gain control and/or wavenumber filtering. Statement 7: The method according to any one of preceding Statements 1-6, wherein the weight function comprises sinusoidal phase, amplitude, and depth, and the plurality of feature kernels comprise sinusoidal wave functions with different amplitudes. Statement 8: A system for determining one or more geological characteristics of a borehole, the system comprising: an azimuthal borehole measurement tool operable to obtain at least one azimuthal borehole image; at least one processor; and a memory coupled to the at least one processor having instructions stored therein, which when executed by the at least one processor, cause the at least one processor to perform a plurality of functions, including functions to: obtain the at least one azimuthal borehole image; generate a synthetic image by sparse convolution of a weight function and a plurality of feature kernels; determine an optimal weight function that minimizes a difference between the synthetic image and the at least one azimuthal borehole image by overlaying the synthetic image with the plurality of feature kernels scaled by corresponding weight functions on the at least one azimuthal borehole image, wherein the optimal weight function is the corresponding weight function of the plurality of feature kernels which produces the synthetic image substantially matching the at least one azimuthal borehole image; and determine the one or more geological characteristics of the borehole based on the optimal weight function and corresponding feature kernel. Statement 9: The system according to Statement 8, wherein the one or more geological characteristics include one or more dips between formation beds and/or one or more voids, wherein the one or more dips include a dip angle and a dip orientation. Statement 10: The system according to Statement 8 or 9, wherein determining the optimal weight function includes overlaying the synthetic image with the plurality of feature kernels scaled by corresponding weight functions for a plurality of iterations, wherein each iteration retains one or more of the plurality of feature kernels scaled by corresponding weight functions most closely matching the at least one azimuthal borehole image. Statement 11: The system according to any one of Statements 8-10, wherein the plurality of functions further include a function to: steer a downhole drilling tool based on the one or more geological characteristics. Statement 12: The system according to any one of Statements 8-11, wherein determining the optimal weight function that minimizes a difference between the synthetic image and the at least one azimuthal borehole image comprises solving an inversion equation using gradient hard thresholding pursuit. Statement 13: The system according to any one of Statements 8-12, wherein the at least one azimuthal borehole image is preprocessed prior to determining the optimal weight function, wherein the at least one azimuthal borehole image is preprocessed using automated gain control and/or wavenumber filtering. Statement 14: The system according to any one of Statements 8-13, wherein the weight function comprises sinusoidal phase, amplitude, and depth, and the plurality of feature kernels comprise sinusoidal wave functions with different amplitudes. Statement 15: A method for picking one or more dips, the method comprising: deploying an azimuthal borehole measurement tool into a borehole; obtaining at least one azimuthal borehole image utilizing the azimuthal borehole measurement tool; generating a synthetic image by sparse convolution of a sinusoidal weight function and a plurality of feature kernels; determining an optimal sinusoidal weight function that minimizes a difference between the synthetic image and the at least one azimuthal borehole image by overlaying the synthetic image with the plurality of feature kernels scaled by corresponding sinusoidal weight functions on the at least one azimuthal borehole image, wherein the optimal sinusoidal weight function is the corresponding sinusoidal weight function of the plurality of feature kernels which produces the synthetic image substantially matching the at least one azimuthal borehole image; and determining one or more geological characteristics of the borehole based on the optimal sinusoidal weight function and the corresponding feature kernel. Statement 16: The method according to Statement 15, wherein the one or more geological characteristics are the one or more dips having a dip angle and a dip orientation. Statement 17: The method according to any one of Statements 15-16, the method further comprising steering a downhole drilling tool based on the one or more geological characteristics. Statement 18: The method according to any one of Statements 15-17, wherein determining the optimal sinusoidal weight function that minimizes the difference between the synthetic image and the at least one azimuthal borehole image comprises solving an inverse equation using gradient hard thresholding pursuit. Statement 19: The method according to any one of Statements 15-18, wherein the at least one azimuthal borehole image is preprocessed prior to determining the optimal sinusoidal weight function, wherein the at least one azimuthal borehole image is preprocessed using automated gain control and/or wavenumber filtering. Statement 20: The method according to any one of Statements 15-19, wherein determining an optimal weight function includes overlaying the synthetic image with the plurality of feature kernels scaled by corresponding sinusoidal weight functions for a plurality of iterations, wherein each iteration retains one or more of the plurality of feature kernels scaled by corresponding sinusoidal weight functions most closely matching the at least one azimuthal borehole image.

What is claimed is:

1. A method for determining one or more geological characteristics of a borehole, the method comprising:
deploying an azimuthal borehole measurement tool into the borehole;
obtaining at least one azimuthal borehole image utilizing the azimuthal borehole measurement tool;
generating a synthetic image by sparse convolution of a weight function and a plurality of feature kernels;
determining an optimal weight function that minimizes a difference between the synthetic image and the at least one azimuthal borehole image by overlaying the synthetic image with the plurality of feature kernels scaled by corresponding weight functions on the at least one azimuthal borehole image, wherein the optimal weight function is the corresponding weight function of the plurality of feature kernels which produces the synthetic image substantially matching the at least one azimuthal borehole image; and
determining the one or more geological characteristics of the borehole based on the optimal weight function and corresponding feature kernel.

2. The method of claim 1, wherein the one or more geological characteristics include one or more dips between formation beds and/or one or more voids, wherein the one or more dips between formation beds include a dip angle and a dip orientation.

3. The method of claim 1, wherein determining the optimal weight function includes overlaying the synthetic image with the plurality of feature kernels scaled by corresponding weight functions for a plurality of iterations, wherein each iteration retains one or more of the plurality of feature kernels scaled by the corresponding weight functions most closely matching the at least one azimuthal borehole image.

4. The method of claim 1, the method further comprising steering a downhole drilling tool based on the one or more geological characteristics.

5. The method of claim 1, wherein determining the optimal weight function that minimizes the difference between the synthetic image and the at least one azimuthal borehole image comprises solving an inversion equation using gradient hard thresholding pursuit.

6. The method of claim 1, wherein the at least one azimuthal borehole image is preprocessed prior to determining the optimal weight function, wherein the at least one azimuthal borehole image is preprocessed using automated gain control and/or wavenumber filtering.

7. The method of claim 1, wherein the weight function comprises sinusoidal phase, amplitude, and depth, and the plurality of feature kernels comprise sinusoidal wave functions with different amplitudes.

8. A system for determining one or more geological characteristics of a borehole, the system comprising:
an azimuthal borehole measurement tool operable to obtain at least one azimuthal borehole image;
at least one processor; and
a memory coupled to the at least one processor having instructions stored therein, which when executed by the at least one processor, cause the at least one processor to perform a plurality of functions, including functions to:
obtain the at least one azimuthal borehole image;
generate a synthetic image by sparse convolution of a weight function and a plurality of feature kernels;
determine an optimal weight function that minimizes a difference between the synthetic image and the at least one azimuthal borehole image by overlaying the synthetic image with the plurality of feature kernels scaled by corresponding weight functions on the at least one azimuthal borehole image, wherein the optimal weight function is the corresponding weight function of the plurality of feature kernels which produces the synthetic image substantially matching the at least one azimuthal borehole image; and
determine the one or more geological characteristics of the borehole based on the optimal weight function and corresponding feature kernel.

9. The system of claim 8, wherein the one or more geological characteristics include one or more dips between formation beds and/or one or more voids, wherein the one or more dips include a dip angle and a dip orientation.

10. The system of claim 9, wherein determining the optimal weight function includes overlaying the synthetic image with the plurality of feature kernels scaled by corresponding weight functions for a plurality of iterations, wherein each iteration retains one or more of the plurality of feature kernels scaled by corresponding weight functions most closely matching the at least one azimuthal borehole image.

11. The system of claim 8, wherein the plurality of functions further include a function to: steer a downhole drilling tool based on the one or more geological characteristics.

12. The system of claim 8, wherein determining the optimal weight function that minimizes a difference between the synthetic image and the at least one azimuthal borehole image comprises solving an inversion equation using gradient hard thresholding pursuit.

13. The system of claim 8, wherein the at least one azimuthal borehole image is preprocessed prior to determining the optimal weight function, wherein the at least one azimuthal borehole image is preprocessed using automated gain control and/or wavenumber filtering.

14. The system of claim 8, wherein the weight function comprises sinusoidal phase, amplitude, and depth, and the plurality of feature kernels comprise sinusoidal wave functions with different amplitudes.

15. A method for picking one or more dips, the method comprising:
deploying an azimuthal borehole measurement tool into a borehole;
obtaining at least one azimuthal borehole image utilizing the azimuthal borehole measurement tool;
generating a synthetic image by sparse convolution of a sinusoidal weight function and a plurality of feature kernels;
determining an optimal sinusoidal weight function that minimizes a difference between the synthetic image and the at least one azimuthal borehole image by overlaying the synthetic image with the plurality of feature kernels scaled by corresponding sinusoidal weight functions on the at least one azimuthal borehole image, wherein the optimal sinusoidal weight function is the corresponding sinusoidal weight function of the plurality of feature kernels which produces the synthetic image substantially matching the at least one azimuthal borehole image; and
determining one or more geological characteristics of the borehole based on the optimal sinusoidal weight function and corresponding feature kernel.

16. The method of claim 15, wherein the one or more geological characteristics are the one or more dips having a dip angle and a dip orientation.

17. The method of claim 15, the method further comprising steering a downhole drilling tool based on the one or more geological characteristics.

18. The method of claim 15, wherein determining the optimal sinusoidal weight function that minimizes the difference between the synthetic image and the at least one azimuthal borehole image comprises solving an inverse equation using gradient hard thresholding pursuit.

19. The method of claim 15, wherein the at least one azimuthal borehole image is preprocessed prior to determining the optimal sinusoidal weight function, wherein the at least one azimuthal borehole image is preprocessed using automated gain control and/or wavenumber filtering.

20. The method of claim 15, wherein determining an optimal weight function includes overlaying the synthetic image with the plurality of feature kernels scaled by corresponding sinusoidal weight functions for a plurality of iterations, wherein each iteration retains one or more of the plurality of feature kernels scaled by corresponding sinusoidal weight functions most closely matching the at least one azimuthal borehole image.
